(19) United States
(12) Patent Application Publication
(10) Pub. No.: US 2007/0219067 A1
(43) Pub. Date: Sep. 20, 2007

(54) Ellipticycle

(76) Inventor: Paul Jeffery Mapstone, Endwell, NY (US)

Correspondence Address: Paul Mapstone, 1010 Elmwood Drive, Endwell, NY, 13760, US

(21) Appl. No.: 11/373,691

(22) Filed: Mar. 13, 2006

(51) Int. Cl. B62B 15/00; A63B 22/06

(52) U.S. Cl. 482/57; 280/1

(57) ABSTRACT

A moving exercise apparatus that utilizes both arm levers and foot pedals to apply rotational force to the rear wheels, which propels the apparatus in a forward or reverse motion. A center steering handle in the front of the apparatus steers the front wheels and mounts the break handles. The braking system includes brake cables, pads and handle grips mounted on the center steering handle, much like that on a common bicycle. The brake pads are attached to the front and rear axles.

### RELATED APPLICATIONS

### Field of the Invention

The present invention relates to exercise apparatus and, more particularly, to a mobile four wheeled exercise cycling apparatus.

### BACKGROUND OF THE INVENTION

Studies show that running and cycling can be very harmful to the joints of the knees and back. One way to eliminate the stresses exerted on these joints is the use of elliptical machines. An elliptical machine simulates walking, jogging and climbing with arm exercise. The downfall to elliptical machines is that they are stationary and exercise may become boring and tedious. Cycling devices such as bicycles and recumbant bikes allow the user to exercise outdoors, which eliminates the boring and tedious indoor atmosphere, but may put an awkward strain on the user's back. Also there has never been mobile apparatus that uses arms to assist in the motion.

United States Patent Application number 20050170934, published Aug. 4, 2005, for Elliptical Byke, by Myles, Tyrone Adree, included by reference herein, discloses the invention is designed for any user types and more specifically it allows t-he user to maximize their exercise workout by providing them with more options of either utilizing the elliptical portion (providing the running effect) or the exercise bike portion (providing the cycling effect) of the machine. Both portions provide an exercise workout; when the user feels fatigue from their aerobic workout by using the elliptical portion, they have the luxury of continuing their cardiovascular workout by using the bike portion of the machine while being seated.

United States Patent Application number 20050181912, published Aug. 18, 2005, for Elliptical exercise apparatus with adjustable crank, by Eschenbach, Paul William, included by reference herein, discloses the invention relates to a standup exercise apparatus that simulates walking, jogging and climbing with arm exercise. More particularly, the invention relates to an exercise machine having separately supported pedals for the feet and arm exercise coordinated with the motion of the feet. Elliptical cross trainers guide the feet along a generally elliptical shaped curve to simulate the motions of jogging and climbing. Existing elliptical cross trainers often use excessive pedal articulation which can overwork the ankle to achieve a longer stride. The present invention is an improved elliptical exercise machine capable of extended exercise with less pedal articulation that is more ankle friendly. One end of a foot support member has a pedal following elliptical motion while the other end is guided by an orbital link to drive an alternator and flywheel. The resulting pedal motion is foot friendly. Stride length can be adjusted. Handles are coordinated with the foot support members for arm exercise.

United States Patent Application number 20060040795, published Feb. 23, 2006, for ORBITAL EXERCISE MACHINE WITH ARM EXERCISE, by Eschenbach; Paul William, included by reference herein, discloses the invention relates to a standup exercise apparatus that simulates walking, jogging and climbing with arm exercise. More particularly, the present invention relates to an exercise machine having separately supported pedals for the feet and arm exercise coordinated with the motion of the feet. Elliptical cross trainers guide the feet along a generally elliptical shaped curve to simulate the motions of jogging and climbing. Existing elliptical cross trainers often use excessive pedal articulation which can overwork the ankle to achieve a longer stride. The present invention is an improved elliptical exercise machine capable of extended exercise with less pedal articulation that is more ankle friendly. One end of a foot support member is guided by a guide link for back and forth movement while the other end is guided by an orbital link to drive an alternator and flywheel. The resulting pedal motion is foot friendly. Handles are coordinated with the foot support members for arm exercise.

Conventional elliptical trainers provide low impact on the user's joints, but don't provide the ability to exercise outdoors and may become boring and tedious.

It is therefore an object of the invention to utilize both arms and legs in an exercising apparatus.

It is another object of the invention to allow the user to stand while using an exercising apparatus.

It is another object of the invention to allow the user to get the benefits of a low impact apparatus.

It is another object of the invention to allow the user to get a full body workout while outdoors.

It is another advantage to provide a low impact elliptical exercise apparatus that can be used outdoors.

### SUMMARY OF THE INVENTION

In accordance with the present invention, there is provided an exercise apparatus that utilizes both arm levers and foot pedals to apply rotational force to rear wheels, which moves the apparatus in a forward or reverse motion. A center steering handle in the front of the apparatus steers the front wheels and mounts break handles. The braking system includes brake cables, pads and handle grips mounted on the center steering handle, much like that on a common bicycle. The break mechanisms are attached to the front wheels and rear axle.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a front view of the ellipticycle;

FIG. 2 is a left view of an ellipticycle;

FIG. 3 is a bottom detail view of a front axle and wheels; and

FIG. 4 is a detail view of a rear axle and wheels.

For purposes of clarity and brevity, like elements and components will bear the same designations and numbering throughout the Figures.

### DESCRIPTION OF THE PREFERRED EMBODIMENT

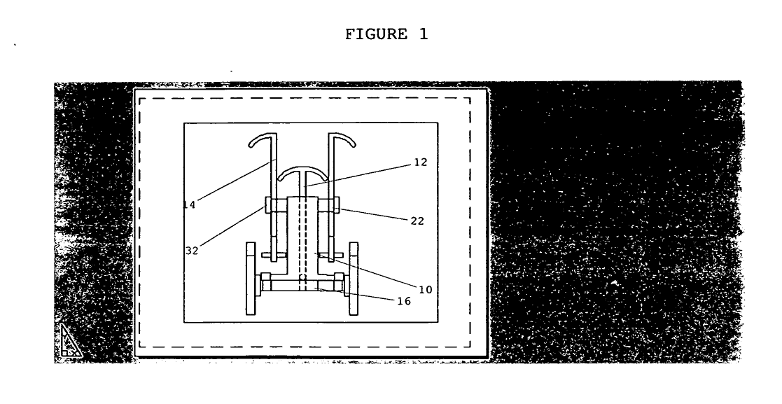

FIG. 1 is a front view of the apparatus 5. The overall width of the apparatus 5 is 25″ and the height is 55″ in the preferred embodiment. Of course, other dimensions may be used when the apparatus 5 is to be used for children or over-sized adults. A frame 10 may be fabricated of aluminum or low carbon steel and shall be produced as one piece. unilateral handlebars 14 are mounted to frame 10 by the use of mounting brackets 32 which are connected to bearings 22 inserted into frame 10. The unilateral handlebars 14 may be fabricated of aluminum or low carbon steel pipe material.

The lowest end of the unilateral handlebars 14 is attached to foot pedal bars 30 with a pivot joint 40. The foot pedal bars 30 may be fabricated of aluminum or low carbon steel. foot pads 28 are mounted on top of the foot pedal bars 30 using four machine screws 42. The foot pads 28 are stationary and do not move up or down the foot pedal bars 30. The foot pads 28 may be fabricated of plastic with a textured surface to prevent the user's foot from slipping.

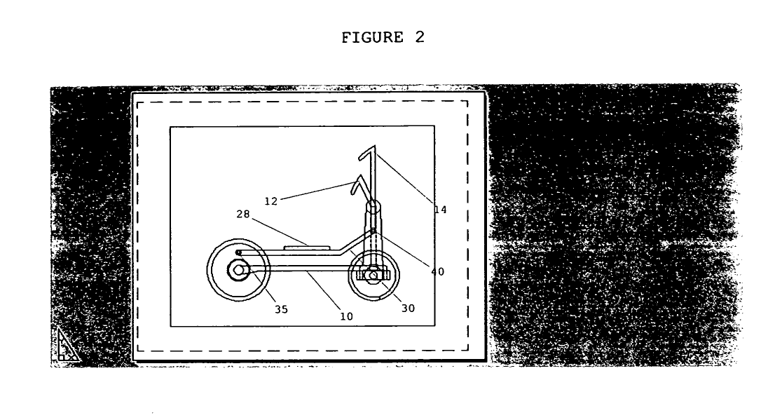

FIG. 2 is a left side view of the apparatus 5. The ends of the foot pedal bars 30 are connected to the rear axle 26. The rear axle 26 may be fabricated of aluminum or low carbon steel bar stock. The rear axle 26 is welded at both ends to the center points of two rear wheels 24.

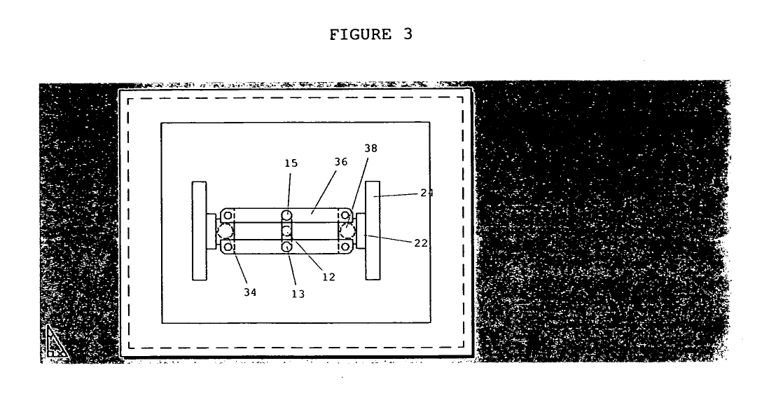

FIG. 3 is a detailed bottom view of the front axle 16. The front axle 16 is attached to two wheels 24 with bearings 22 inserted through the centers thereof. The bearings 22 are mounted to two brackets 34 composed of either low or medium carbon steel. The brackets 34 are fastened to the frame 10 at two frame pivot points 38 on the frame 10. The center handle bar 12 has a two-pronged, forklike shape. The two prongs, prong1 13 and prong2 15, stick through the horizontal members 36 at two places in the front axle 16. The center handle bar 12 may be made of aluminum or low carbon steel piping material and will utilize one flexible joint.

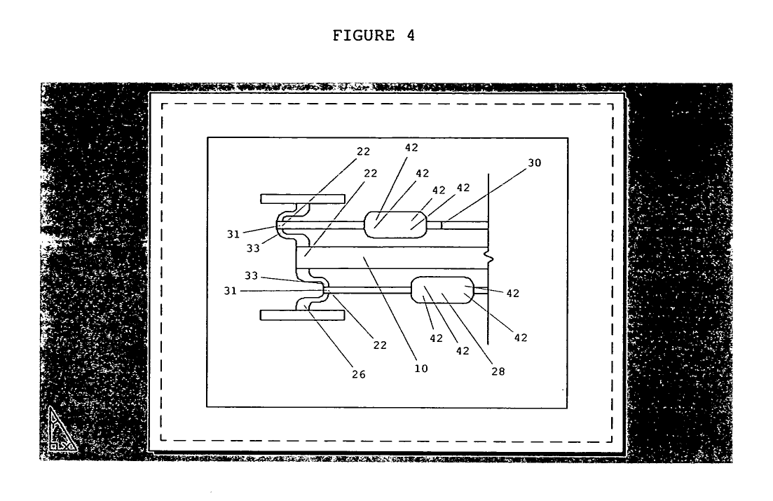

FIG. 4 is a detailed view of the rear axle 26. The rear ends 31 of the two foot pedal bars 30 are connected to the shaft 33 for the rear axle 26. The bent shaft 33 goes through the holes 35 to the rear of each foot pedal bars 30 and bearings 22. The ends of the rear shaft 33 for the rear axle 26 is welded to the center of the two rear wheels 24 to make them one solid revolving unit.

In operation, the user, not shown, of this apparatus 5 grips the unilateral handlebars 14 and pushes or pulls with with his or hers opposite right and left arms in an alternating rowing motion causing a linear force. As the right arm is pulling, the left arm is pushing and vice versa. The unilateral handlebars 14 move in a linear motion and transfer force through the foot pedal bars 30 which in turn convert the force to rotational motion and revolve the rear axle 26. Turning the center handle bar 12, which is one piece with the prongs, shifts the horizontal members 36 in either direction, steering the front wheels 24. As the foot pedal bars 30 move in orbital motion the force is transferred to the shaft 33 at the rear axle 26. As the shaft 33 of the rear axle 26 revolves the rear wheels 24 revolve as well. The force from the shaft 33 is transferred to the wheels 24 and then to the ground that they rest on which propels the entire apparatus 5.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. An ellipticycle for exercising, comprising:
means for providing a stable base that supports the foot pedal bars, unilateral handlebars, center steering handle, and front and rear axles;
means for steering the apparatus;
means for propelling the apparatus with use of the user's arms;
means for racking of the front wheels for turning the apparatus;
means for rotating the rear wheels to propel the apparatus, rotationally connected to said means for propelling the apparatus with use of the user's arms;
means for support feet when operating apparatus;
means for mounting the unilateral handlebars to the frame allowing them to rotate freely;
means for connecting the front wheels to the horizontal members;
means for steer and connect the brackets in front axle, pivotally connected to said means for connecting the front wheels to the horizontal members;
means for mounting frame to brackets on front axle, turnably connected to said means for connecting the front wheels to the horizontal members, and rigidly connected to said means for providing a stable base that supports the foot pedal bars, unilateral handlebars, center steering handle, and front and rear axles;
means for <purpose>;
means for allow rotation of connection between the unilateral handle bars and foot pedal bars;
means for forming a freely pivoting connection between the shaft of the center steering handle and the front horizontal member of the front axle;
means for forming a freely pivoting connection between the shaft of the center steering handle and the rear horizontal member of the front axle; and
means for forming a connection between the rear wheels and rear ends of the foot pedal bars that converts linear motion to rotational motion.

2. The ellipticycle in accordance with claim 1, wherein said means for providing a stable base that supports the foot pedal bars, unilateral handlebars, center steering handle, and front and rear axles comprises a metal, cylindrical frame.

3. The ellipticycle in accordance with claim 1, wherein said means for steering the apparatus comprises a metal, cylindrical center handle bar.

4. The ellipticycle in accordance with claim 1, wherein said means for propelling the apparatus with use of the user's arms comprises a metal, cylindrical unilateral handlebars.

5. The ellipticycle in accordance with claim 1, wherein said means for racking of the front wheels for turning the apparatus comprises a metal front axle.

6. The ellipticycle in accordance with claim 1, wherein said means for rotating the rear wheels to propel the apparatus comprises a metal rear axle.

7. The ellipticycle in accordance with claim 1, wherein said means for support feet when operating apparatus comprises a plastic foot pads.

8. The ellipticycle in accordance with claim 1, wherein said means for mounting the unilateral handlebars to the frame allowing them to rotate freely comprises a metal mounting brackets.

9. The ellipticycle in accordance with claim 1, wherein said means for connecting the front wheels to the horizontal members comprises a metal brackets.

10. The ellipticycle in accordance with claim 1, wherein said means for steer and connect the brackets in front axle comprises a metal horizontal members.

11. The ellipticycle in accordance with claim 1, wherein said means for mounting frame to brackets on front axle comprises a metal frame pivot points.

12. The ellipticycle in accordance with claim 1, wherein said means for <purpose> comprises an apparatus.

13. The ellipticycle in accordance with claim 1, wherein said means for allow rotation of connection between the unilateral handle bars and foot pedal bars comprises a metal pivot joint.

14. The ellipticycle in accordance with claim 1, wherein said means for forming a freely pivoting connection between the shaft of the center steering handle and the front horizontal member of the front axle comprises a metal, cylindrical, solid prong1.

15. The ellipticycle in accordance with claim 1, wherein said means for forming a freely pivoting connection between the shaft of the center steering handle and the rear horizontal member of the front axle comprises a metal, cylindrical, solid prong2.

16. The ellipticycle in accordance with claim 1, wherein said means for forming a connection between the rear wheels and rear ends of the foot pedal bars that converts linear motion to rotational motion comprises a metal, cylindrical, solid shaft.

17. An ellipticycle for exercising, comprising:
a metal, cylindrical frame, for providing a stable base that supports the foot pedal bars, unilateral handlebars, center steering handle, and front and rear axles;
a metal, cylindrical center handle bar, for steering the apparatus;
a metal, cylindrical unilateral handlebars, for propelling the apparatus with use of the user's arms;
a metal front axle, for racking of the front wheels for turning the apparatus;
a metal rear axle, for rotating the rear wheels to propel the apparatus, rotationally connected to said unilateral handlebars;
a plastic foot pads, for support feet when operating apparatus;
a metal mounting brackets, for mounting the unilateral handlebars to the frame allowing them to rotate freely;
a metal brackets, for connecting the front wheels to the horizontal members;
a metal horizontal members, for steer and connect the brackets in front axle, pivotally connected to said brackets;
a metal frame pivot points, for mounting frame to brackets on front axle, turnably connected to said brackets, and rigidly connected to said frame;
an apparatus, for <purpose>;
a metal pivot joint, for allow rotation of connection between the unilateral handle bars and foot pedal bars;
a metal, cylindrical, solid prong1, for forming a freely pivoting connection between the shaft of the center steering handle and the front horizontal member of the front axle;
a metal, cylindrical, solid prong2, for forming a freely pivoting connection between the shaft of the center steering handle and the rear horizontal member of the front axle; and
a metal, cylindrical, solid shaft, for forming a connection between the rear wheels and rear ends of the foot pedal bars that converts linear motion to rotational motion.

18. The ellipticycle as recited in claim 17, further comprising:
a metal, rectangular foot pedal bars, for connecting the lower pivot joint of the unilateral handle bars to the rear shaft of the rear axle, pivotally connected to said unilateral handlebars, and rigidly connected to said foot pads.

19. An ellipticycle for exercising, comprising:
a metal, cylindrical frame, for providing a stable base that supports the foot pedal bars, unilateral handlebars, center steering handle, and front and rear axles;
a metal, cylindrical center handle bar, for steering the apparatus;
a metal, cylindrical unilateral handlebars, for propelling the apparatus with use of the user's arms;
a metal front axle, for racking of the front wheels for turning the apparatus;
a metal rear axle, for rotating the rear wheels to propel the apparatus, rotationally connected to said unilateral handlebars;
a plastic foot pads, for support feet when operating apparatus;
a metal, rectangular foot pedal bars, for connecting the lower pivot joint of the unilateral handle bars to the rear shaft of the rear axle, rigidly connected to said foot pads, and pivotally connected to said unilateral handlebars;
a metal mounting brackets, for mounting the unilateral handlebars to the frame allowing them to rotate freely;
a metal brackets, for connecting the front wheels to the horizontal members;
a metal horizontal members, for steer and connect the brackets in front axle, pivotally connected to said brackets;
a metal frame pivot points, for mounting frame to brackets on front axle, turnably connected to said brackets, and rigidly connected to said frame;
an apparatus, for <purpose>;
a metal pivot joint, for allow rotation of connection between the unilateral handle bars and foot pedal bars;
a metal, cylindrical, solid prong1, for forming a freely pivoting connection between the shaft of the center steering handle and the front horizontal member of the front axle;
a metal, cylindrical, solid prong2, for forming a freely pivoting connection between the shaft of the center steering handle and the rear horizontal member of the front axle; and
a metal, cylindrical, solid shaft, for forming a connection between the rear wheels and rear ends of the foot pedal bars that converts linear motion to rotational motion.
